(19) United States
(12) Patent Application Publication
(10) Pub. No.: US 2025/0389621 A1
(43) Pub. Date: Dec. 25, 2025

(54) SIMULATION DEVICE AND METHOD FOR ENTIRE PROCESS OF FIRE INITIATION OF MINING BELT

(71) Applicant: CHINA COAL TECHNOLOGY & ENGINEERING GROUP SHENYANG ENGINEERING COMPANY, Shenyang (CN)

(72) Inventors: Xinfeng Cui, Shenyang (CN); Yong SUN, Shenyang (CN); Zhongyu ZHENG, Shenyang (CN); Xiangning MENG, Shenyang (CN); Ruide WANG, Shenyang (CN); Enhui LIU, Shenyang (CN)

(21) Appl. No.: 18/561,195

(22) PCT Filed: Feb. 10, 2023
(86) PCT No.: PCT/CN2023/075309

§ 371 Date: Apr. 29, 2025

(30) Foreign Application Priority Data
Nov. 7, 2022 (CN) 202211381860.5

(51) Int. Cl. G01M 13/023; G01N 21/01; G01N 25/00

(52) U.S. Cl. CPC G01M 13/023; G01N 21/01; G01N 25/00

(57) ABSTRACT

Provided is a simulation device and method for an entire process of fire initiation of a mining belt. The simulation device includes: a workbench, a fixing belt clamp, a sliding belt clamp, heat source assemblies, a traction rope, a traction assembly, a high-speed camera, goose neck pipes, and a multi-parameter sensor. The simulation method includes: clamping a belt sample; selecting five monitoring points from the belt sample, and extending five goose neck pipes to the corresponding monitoring points; reckoning heat required for a heating and spontaneous combustion process of the belt sample, and reversely reckoning power supply parameters; sprinkling coal samples on the belt sample, switching on a power source of the heat source assemblies for heating the belt sample, and acquiring temperature, flue gas components and image data; and analyzing the data, and summarizing a temperature distribution rule of the belt sample and a gas generation rule.

### BACKGROUND OF THE INVENTION

### 1. Field of the Invention

The invention relates to the technical field of a fire research with a belt conveyor, and particularly provides a simulation device and a method for an entire process of fire initiation of a mining belt.

### 2. The Prior Arts

With the continuous improvement of industrial mechanization in China, in order to improve the economic benefits of production, belt conveyor equipment has been widely used in many enterprises due to its advantages of simple structure, long continuous conveying distance, low conveying cost, high conveying efficiency, etc.

A mine belt conveyor is a main fire prone area among mine fires due to external causes. Fire disaster prevention of the mine belt conveyor is a major part of the prevention and control of mine fire areas. Its sudden occurrence and rapid development can quickly cause a threat to personnel on the downwind side, and even due to wind reversion, smoke flows into intake areas to expand hazardous areas or induce gas explosions and other disasters, leading to major casualties and equipment damage accidents.

In order to study the belt fire of the mine belt conveyor, a device and a method are necessary to simulate the entire process of fire initiation of the mining belt. The existing related equipment simulates the process of fire initiation caused by a friction between a belt sample and a roller in the process of the belt being stuck by directly using the friction between the roller and the belt sample. However, the equipment has problems of being complex in operation process, high in danger, weak in operability, etc., so that the early fire initiation process of the belt fire is difficult to accurately simulate. Moreover, since a flame-retardant belt is extremely difficult in fire initiation due to friction, the simulation experiment is long in cycle.

The invention provides a simulation device and a method for an entire process of fire initiation of a mining belt to solve the problems.

### SUMMARY OF THE INVENTION

In order to realize the above purpose, a simulation device for an entire process of fire initiation of a mining belt comprises a workbench, a fixing belt clamp, a sliding belt clamp, heat source assemblies, a traction rope, a traction assembly, a high-speed camera, goose neck pipes and a multi-parameter sensor, wherein the fixing belt clamp and the sliding belt clamp are respectively assembled at two ends of an upper surface of the workbench for clamping a belt sample, the heat source assemblies are uniformly embedded on the upper surface of the workbench, one end of the traction rope is connected with the sliding belt clamp, another end of the traction rope is connected with the traction assembly, the multi-parameter sensor is assembled on a side wall of the workbench, the goose neck pipes are assembled on the multi-parameter sensor, and the high-speed camera is erected on an outer side of the workbench.

A gas collecting pipe with a diameter smaller than that of the corresponding goose neck pipe is coaxially arranged at an inner side of each goose neck pipe, and a plurality of infrared thermal imagers are uniformly arranged in a gap between each gas collecting pipe and the corresponding goose neck pipe.

Further, the heat source assemblies are electrical components such as an electric heating wire or a thermal resistor that can convert electrical energy into thermal energy.

Further, the traction assembly is a heavy hammer or an electrically controlled traction machine, which applies a tension on the belt sample by pulling the sliding belt clamp through the traction rope.

A simulation method for an entire process of fire initiation of a mining belt comprises the following steps:
Step I: clamping the belt sample to the workbench.
Step II: selecting five monitoring points from the belt sample, and sequentially extending data acquiring ends of the five goose neck pipes to the corresponding monitoring points.
Step III: according to a material of the belt sample and a roller, reckoning heat required for a heating and spontaneous combustion process of the belt sample, and reversely reckoning power supply parameters required for simulating the heating and spontaneous combustion process of the belt sample through the heat source assemblies based on the required heat.
Step IV: sprinkling coal samples on a surface of the belt sample, according to the power supply parameters obtained in Step III, setting a power source, then switching on the power source of the heat source assemblies for heating the belt sample, and at the same time, acquiring temperature, flue gas components and image data.
Step V: analyzing the data, and summarizing a temperature distribution rule of the belt sample and a gas generation rule.

Further, the simulation method comprises Step VI: performing repeated experiments based on the rules summarized in Step V and the required belt sample material and the power supply parameters for obtaining the rules, adjusting a position of each monitoring point or adjusting a distance between the data acquiring end of each goose neck pipe and the belt sample.

Further, in the selecting the five monitoring points of Step II, the five monitoring points are located on a transverse center line of the belt sample, and distances between the five monitoring points are the same.

Further, in Step III, the reckoning the parameters comprises:

Determining the material and a size of the belt sample and the roller, whereby a friction resistance coefficient, a roller length and a normal pressure between the belt sample and the roller are all known quantities, according to a calculation method of friction heat and a basic law of thermal conduction, calculating a heat value Qₕₑₐₜ generated by the belt sample due to a friction, wherein the heat value is also an energy E₀ of a lower surface of the belt sample in a process of simulating frictional heating of the belt sample, namely E₀=Qₕₑₐₜ.

According to a radiation heat transfer operational formula, reversely reckoning that when an energy to be transferred to the lower surface of the belt sample is E₀, a heat value that the heat source assemblies need to generate is E₁.

Heating the lower surface of the belt sample by the heat source assemblies by converting electrical energy into thermal energy, and calculating the power supply parameters required to generate the heat value E₁ using the heat source assemblies based on an electric heating formula.

Further, in Step IV, the sprinkling coal samples on the surface of the belt sample comprises:

Evenly spreading the coal samples which are uniformly mixed and have different particle sizes on the surface of the belt sample, with a thickness not exceeding 5 cm.

The device and the method have the beneficial effects that:

Compared to the simulation of the frictional heating process by accelerating the roller, the simulation device simulates the heating process of the belt sample through electric heating, which has a simpler structure, simpler operation, and higher simulation accuracy.

Reverse experiments can be conducted to adjust the position of each monitoring point or adjust the distance between the data acquiring end and the belt sample, thereby providing reference data for the reasonable layout of the monitoring points for the mine belt conveyor.

### BRIEF DESCRIPTION OF DRAWINGS

FIG. 1 shows a main view of the invention;

FIG. 2 shows a top view of a workbench of the invention; and

FIG. 3 shows a radial sectional view of a goose neck pipe of the invention.

In the drawings: 1: workbench; 2: fixing belt clamp; 3: sliding belt clamp; 4: heat source assembly; 5: traction rope; 6: high-speed camera; 7: goose neck pipe; 701: infrared thermal imager; 702: gas collecting pipe; 8: multi-parameter sensor; and 9: smoke exhaust system.

### DETAILED DESCRIPTION OF THE PREFERRED EMBODIMENT

The following is a detailed description of the invention in conjunction with the accompanying drawings.

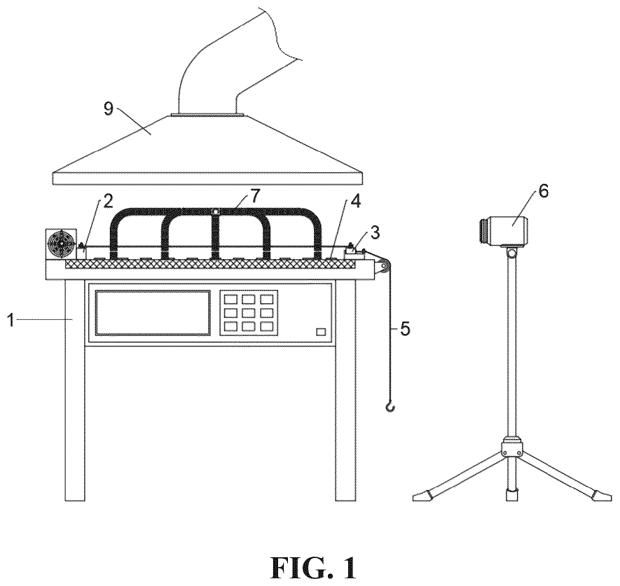

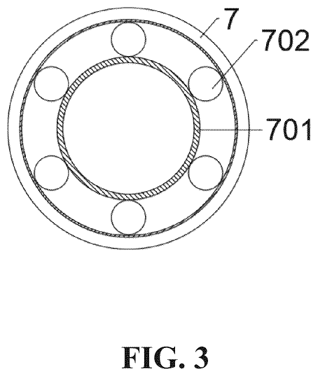

Refer to FIGS. 1-3, a simulation device for an entire process of fire initiation of a mining belt comprises a workbench 1, a fixing belt clamp 2, a sliding belt clamp 3, heat source assemblies 4, a traction rope 5, a high-speed camera 6, goose neck pipes 7 and a multi-parameter sensor 8, wherein the fixing belt clamp 2 and the sliding belt clamp 3 are respectively assembled at two ends of an upper surface of the workbench 1 for clamping a belt sample, the heat source assemblies 4 are uniformly embedded on the upper surface of the workbench 1, one end of the traction rope 5 is connected with the sliding belt clamp 3, another end of the traction rope 5 is connected with a traction assembly, the multi-parameter sensor 8 is assembled on a side wall of the workbench 1, the goose neck pipes 7 are assembled on the multi-parameter sensor 8, and the high-speed camera 6 is erected on an outer side of the workbench 1.

A gas collecting pipe 702 with a diameter smaller than that of the corresponding goose neck pipe 7 is arranged at an inner side of each goose neck pipe 7, and a plurality of infrared thermal imagers 701 are uniformly arranged in a gap between each gas collecting pipe 702 and the corresponding goose neck pipe 7.

Wherein a tail end of each goose neck pipe 7 is a data acquiring end.

The multi-parameter sensor 8 is used for detecting gas components, and the main detected objects comprise cyanide, sulfide, CO, CO₂, CH₄, C₂H₄, H₂, H₂S and SO₂.

The high-speed camera 6 and the multi-parameter sensor 8 are connected with a computer through a line.

The workbench 1 consists of a table top, a box body, and support legs, wherein four support legs are assembled at four corners of a lower surface of the table top, and the box body is assembled on a bottom surface of the table top.

An insulation interlayer is arranged in the table top.

Preferably, the insulation interlayer consists of two layers of high-temperature resistant stainless steel plates and insulation cotton.

The support legs are retractable hydraulic pillars used for adjusting an inclination angle of the table top, which is convenient for simulating the working state of the conveyor belt at different climbing angles.

A power supply unit and a control panel are arranged in the box body.

Five goose neck pipes 7 are arranged.

A smoke exhaust system 9 is arranged above the workbench 1.

The smoke exhaust system 9 consists of a smoke removal device, a smoke exhaust pipeline, and a centrifugal fan, and has the functions of eliminating smoke and diluting toxic and harmful gas.

The heat source assemblies 4 are electrical components such as an electric heating wire or a thermal resistor that can convert electrical energy into thermal energy.

Preferably, the heat source assemblies 4 are a plurality of electric furnace wires with a maximum thermal power of 10 KW, the electric furnace wires are evenly spaced and distributed in parallel, the experimental requirements of existing belts with widths of 1.2 m, 1 m, and 0.8 m can be met; and each electric furnace wire is independently controlled to achieve section-compartmentalized heating or collaborative heating of the belt.

The traction assembly is connected as a heavy hammer or an electrically controlled traction machine, which applies a tension on the belt sample by pulling the sliding belt clamp 3 through the traction rope 5.

The material of the gas collecting pipe 702 is Teflon.

A simulation method for an entire process of fire initiation of a mining belt comprises the following steps:
Step I: a section of the to-be-tested belt is cut based on the size of the workbench 1 and the minimum distance between the fixing belt clamp 2 and the sliding belt clamp 3 by a working staff, and two ends of the belt are clamped onto the fixing belt clamp 2 and the sliding belt clamp 3 respectively.
Step II: five monitoring points are selected from the belt, and data acquiring ends of the five goose neck pipes 7 are sequentially extended to the corresponding monitoring points.

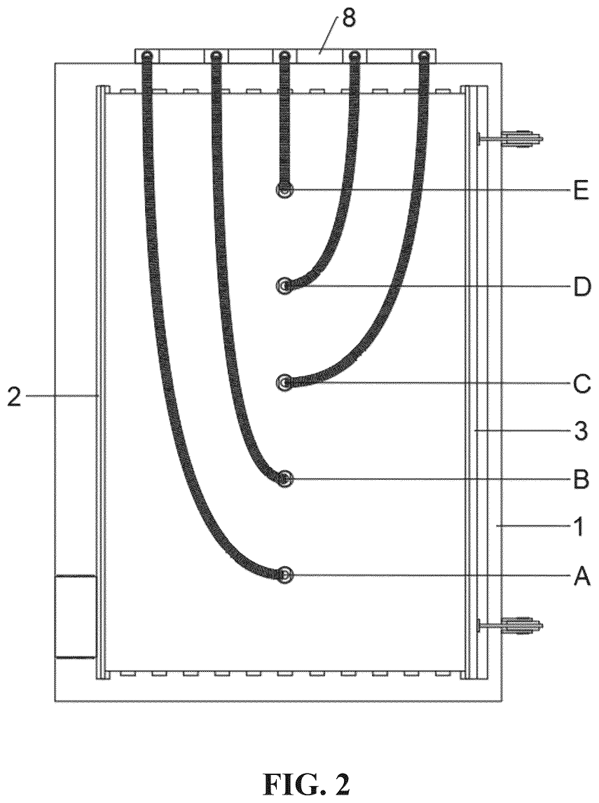

As shown in FIG. 2, the five monitoring points A, B, C, D and E are located on a transverse center line of the belt, and the distances between the five monitoring points are the same.

A vertical distance between the data acquiring end and the surface of the belt shall not exceed 10 cm.
Step III: according to a material of the belt and the roller, heat required for a heating and spontaneous combustion process of the belt is reckoned.

According to the friction between the belt and the roller, which is a dynamic friction, and the heat generated by the friction is heat conduction Qₕₑₐₜ (J), the friction resistance coefficient of the belt is known to be μ (J·(N·m)⁻¹), the rotational length of the roller is L (m), and the pressure on the belt caused by the roller is F_{N} (N); according to the friction heat formula, it can be concluded that:

$${Q}_{h e a t} = μ {F}_{N} L .$$

According to the radiation heat transfer calculation formula, it can be concluded that:

$$Φ = ε A σ {T}^{4} .$$

T₁(T) is set as the temperature of the heat source assemblies 4: T₂(T) is the temperature of the lower surface of the belt: E₁ is the emissivity of the heat source assemblies 4; ε₂ is the emissivity of the belt: A is the radiation area: E₁ (J) is the heat of the heat source assemblies 4; E₀ (J) is the heat on the lower surface of the belt; σ is a Stephen-Boltzmann constant (5.67×10⁻⁸ W/(m²·T⁴)): φ (J) is radiation heat, and according to the radiation heat transfer calculation formula, it can be inferred that:

$$φ = \frac{A ( {E}_{1} - {E}_{0} )}{\frac{1}{{ε}_{1}} + \frac{1}{{ε}_{2}} - 1} .$$

When the heat source assemblies 4 are heated, heat transfer is performed between the heat source assemblies and the belt mainly through two manners of convection heat transfer and radiation heat transfer. However, due to the close distance between the heat source assemblies 4 and the mining belt, it can be regarded as the radiation heat transfer between parallel plates, and the convection heat transfer process is ignored. To simulate the process of belt friction heat generation through the radiation heat transfer, the heat E₀ received by the lower surface of the belt should be equal to the heat Qₕₑₐₜ generated by friction, that is, E₀=Qₕₑₐₜ, and the heat is transmitted to the lower surface of the belt through radiation. In order to receive the heat E₀ on the lower surface of the belt, the radiation heat φ emitted by the heat source assemblies 4 should be equal to E₀, that is, φ=E₀=Qₕₑₐₜ.

Therefore, the heat E₁ that the heat source assemblies 4 should have is calculated.

The heat source assemblies 4 heat the bottom side of the belt by converting electrical energy into thermal energy, that is, the heat released by the heat source assemblies 4 after being energized is Q_{electricity}. According to the electric heating formula, it can be inferred that:

$${Q}_{electricity} = {I}^{2} Rt .$$

Therefore, Q_{electricity}=E₁.

Finally, the power supply parameters required to simulate the heating process of the belt are obtained: current value I, resistance value R of the heat source assemblies 4, and electrification time t.
Step IV: coal samples are sprinkled on a surface of the belt, according to the power supply parameters obtained in Step III, a power source is set, then the power source of the heat source assemblies 4 is switched on for heating the belt, the frictional heating process of the belt in working condition is simulated, and at the same time, temperature, flue gas components and image data are acquired.

Coal samples which are uniformly mixed and have different particle sizes are evenly spread on the upper surface of the mining belt, with a thickness not exceeding 5 cm (the thickness of the laid coal samples is adjusted according to the testing requirements to achieve the purpose of testing the ignition effect of different coal seam thicknesses), the infrared thermal imagers 701 at the five data acquiring ends monitor the temperature changes at the five monitoring points of the belt. The high-speed camera acquires image information on the spontaneous combustion process of the belt, such as discoloration, deformation, combustion, and fracture. The flue gas above the monitoring points is introduced into the multi-parameter sensor 8 through the gas collecting pipe 702, and the flue gas components are analyzed.
Step V: the data is analyzed, and a temperature distribution rule of the belt and a gas generation rule are summarized.

The simulation device uses thermal radiation to simulate the entire process of a fire of the mining belt. By using different current powers to simulate the ignition rule of mining belts under different loads, it can be intuitively and quickly understood the changes in a temperature field and a gas generation rule in the heating process of the mining belts under laboratory conditions. It is used to simulate the evolution rule of fires of belts of the mine belt conveyor, and provide theoretical basis for monitoring, warning, and preventing the fires of the belts of the mine belt conveyor.
Step VI: repeated experiments are performed based on the rules summarized in Step V and the required belt material and the power supply parameters for obtaining the rules, a position of each monitoring point is adjusted or a distance between the data acquiring end of each goose neck pipe 7 and the belt is adjusted, the differences in feedback data from the positions of the different monitoring points or the positions of the data acquiring ends are summarized to evaluate the monitoring effect of the position of each monitoring point or the position of each data acquiring end.

After repeatedly measuring and recording a set of belt ignition and heating parameters, the repeated experiments are performed by using the data as a known amount. In the experiment process, the position of each monitoring point is adjusted or the distance between the data acquiring end of each goose neck pipe 7 and the belt is adjusted, the sensitivity of the monitoring ends under different heat source powers is tested and the distance between the data acquiring ends and the belt under the same heat source power is tested to determine the impact generated by the size of reaction threshold values of the monitoring ends, as a reference for arranging reasonable monitoring points for the mine belt conveyors.

The above content is only a preferred embodiment of the invention. For those skilled in the art, many changes can be made in specific implementations and application scope based on the ideas of the invention. As long as these changes do not deviate from the concept of the invention, they all fall within the protection scope of the invention.

What is claimed is:

1. A simulation device for an entire process of fire initiation of a mining belt, comprising: a workbench; a fixing belt clamp; a sliding belt clamp; heat source assemblies; a traction rope, a traction assembly; a high-speed camera, goose neck pipes; and a multi-parameter sensor,
wherein the fixing belt clamp and the sliding belt clamp are respectively assembled at two ends of an upper surface of the workbench for clamping a belt sample,
the heat source assemblies are uniformly embedded on the upper surface of the workbench,
one end of the traction rope is connected with the sliding belt clamp, another end of the traction rope is connected with the traction assembly,
the multi-parameter sensor is assembled on a side wall of the workbench, the goose neck pipes are assembled on the multi-parameter sensor, and
the high-speed camera is erected on an outer side of the workbench, and
wherein a gas collecting pipe with a diameter smaller than that of the corresponding goose neck pipe is coaxially arranged at an inner side of each goose neck pipe, and
a plurality of infrared thermal imagers are uniformly arranged in a gap between each gas collecting pipe and the corresponding goose neck pipe.

2. The simulation device for the entire process of fire initiation of the mining belt of claim 1, wherein the heat source assemblies are electrical components including an electric heating wire or a thermal resistor that convert electrical energy into thermal energy.

3. The simulation device for the entire process of fire initiation of the mining belt of claim 1, wherein the traction assembly is a heavy hammer or an electrically controlled traction machine, which applies a tension on the belt sample by pulling the sliding belt clamp through the traction rope.

4. A simulation method for an entire process of fire initiation of a mining belt, applying the simulation device for the entire process of fire initiation of the mining belt of claim 1, and comprising the following steps:
Step I: clamping the belt sample to the workbench;
Step II: selecting five monitoring points from the belt sample, and sequentially extending data acquiring ends of the five goose neck pipes to the corresponding monitoring points;
Step III: according to a material of the belt sample and a roller, reckoning heat required for a heating and spontaneous combustion process of the belt sample, and reversely reckoning power supply parameters required for simulating the heating and spontaneous combustion process of the belt sample through the heat source assemblies based on the required heat;
Step IV: sprinkling coal samples on a surface of the belt sample, according to the power supply parameters obtained in Step III, setting a power source, then switching on the power source of the heat source assemblies for heating the belt sample, and at the same time, acquiring temperature, flue gas components and image data; and
Step V: analyzing the data, and summarizing a temperature distribution rule of the belt sample and a gas generation rule.

5. The simulation method for the entire process of fire initiation of the mining belt of claim 4, further comprising: Step VI: performing repeated experiments based on the rules summarized in Step V and the required belt sample material and the power supply parameters for obtaining the rules, adjusting a position of each monitoring point or adjusting a distance between the data acquiring end of each goose neck pipe and the belt sample.

6. The simulation method for the entire process of fire initiation of the mining belt of claim 4, wherein in the selecting the five monitoring points of Step II, the five monitoring points are located on a transverse center line of the belt sample, and distances between the five monitoring points are the same.

7. The simulation method for the entire process of fire initiation of the mining belt of claim 4, wherein in Step III, the reckoning the parameters comprises:
determining the material and a size of the belt sample and the roller, whereby a friction resistance coefficient, a roller length and a normal pressure between the belt sample and the roller are all known quantities, according to a calculation method of friction heat and a basic law of thermal conduction, calculating a heat value Qₕₑₐₜ generated by the belt sample due to a friction, wherein the heat value is also an energy E₀ of a lower surface of the belt sample in a process of simulating frictional heating of the belt sample, namely E₀=Qₕₑₐₜ;
according to a radiation heat transfer operational formula, reversely reckoning that when an energy to be transferred to the lower surface of the belt sample is E₀, a heat value that the heat source assemblies need to generate is E₁; and
heating the lower surface of the belt sample by the heat source assemblies by converting electrical energy into thermal energy, and calculating the power supply parameters required to generate the heat value E₁ using the heat source assemblies based on an electric heating formula.

8. The simulation method for the entire process of fire initiation of the mining belt of claim 4, wherein in Step IV, the sprinkling the coal samples on the surface of the belt sample comprises:
evenly spreading the coal samples which are uniformly mixed and have different particle sizes on the surface of the belt sample, with a thickness not exceeding 5 cm.
